(19) United States
(12) Patent Application Publication
(10) Pub. No.: US 2012/0325197 A1
(43) Pub. Date: Dec. 27, 2012

(54) SYSTEMS AND METHODS FOR AUTOMATION OF A CONTROL KNOB UNIT

(76) Inventors: Ferdinand Villegas Legaspi, Chino, CA (US); Perfecto Ferrer Gallardo, JR., Los Angeles, CA (US); Fernando Medina Bernardo, Chino, CA (US)

(21) Appl. No.: 13/535,317

(22) Filed: Jun. 27, 2012

Related U.S. Application Data
(60) Provisional application No. 61/571,379, filed on Jun. 27, 2011.

(51) Int. Cl. F24C 3/12; F23N 5/24; F16K 17/36

(52) U.S. Cl. 126/42; 137/78.4; 431/18

(57) ABSTRACT

A system and method for automatically rotating a control knob unit on an appliance or other device to an Off position upon the occurrence of a safety event is provided. The control knob unit may be secured to and engaged with an operational shaft on the appliance which controls the flow of gas or power to the appliance. The system may include one or more detectors (or detector modules) that are configured to emit a signal upon an occurrence of the event, such as a fire, which may be an early indication of a developing emergency. The signal may be in the form of an audible alert, such as sound (or sound waves). A data transceiver processing module may receive a plurality of sound waves and analyze the plurality of sound waves for a variation in frequency (or Doppler Effect) to determine if any of the sound waves originate from the one or more detector modules.

### CLAIM OF PRIORITY

The present Application for Patent claims priority to U.S. Provisional Application No. 61/571,379 entitled “Methods and Automation of Appliances Control Knob”, filed Jun. 27, 2011, and hereby expressly incorporated by reference herein.

### FIELD

The present invention relates to the field of automated safety capabilities for appliances or other devices, in particular, to systems and methods for automatically positioning a control knob unit to an Off position upon the occurrence of a safety event. Positioning the control knob unit to an Off position causes the gas and/or electricity emanating from the appliances, such as from burners on a stove, to terminate.

### BACKGROUND OF THE INVENTION

A large number of residential and commercial fires could be prevented if stopped from proliferating during their early stages. Many of these residential and commercial fires originate in the kitchen as overheated cooking oils or greases during cooking can easily ignite which result in potentially dangerous fires leading to the production of smoke and fire. Within minutes of bursting into flames, a fire may consume the contents, walls and ceiling of the room where the fire started and the combination of heat, smoke and carbon monoxide can kill everyone in the area.

Furthermore, in commercial eating establishments, fires from cooking devices can be devastating, often causing cessation of normal business activities for days or weeks, and sometimes permanently. Due to the nature of cooking, the threat of a fire is always present. Having the means to prevent and/or detect a fire in and around a cooking device before the fire has a chance to spread is essential to saving lives and limiting damage.

As these types of fires proliferate when they are unattended, it is important to extinguish or suppress these fires quickly. Generally smoke detectors are used to detect the fires and issue an audible and/or visual alarm to alert individuals in the vicinity that a fire is present, allowing for actions to be taken to extinguish the fire. However, if no one is around to hear and/or see the alarm, the fire will continue to burn causing significant damage.

Another possible cause of a fire is the danger of a gas explosion as a result from gas leaking from broken gas pipes following an earthquake. Sometimes the damage caused by the earthquake may not appear significant, but if the gas accumulates and explodes due to the gas leak, the damage could be catastrophic and life threatening.

One way to reduce damage caused by a fire and the risk of post-earthquake damage is to shut off the appliance, or other device, where the fire started. However, if no one is around, the appliance or other device cannot be shut off. Although devices exist to shut off a gas line in the event of an earthquake, a system and/or device does not exist for automatically turning off the appliance or other device by automatically rotating the control knob(s) of the appliance or other device to an Off position, upon the detection of an audible alert from detectors, such as smoke detectors, gas detectors for detecting carbon monoxide gas, natural gas, propane, and other toxic gas, fire detectors, flame detectors, heat detectors, infra-red sensors and ultra-violet sensors.

Consequently, systems and devices for shutting off an appliance or other device by automatically rotating control knob(s) to an Off position upon the occurrence of a safety event is needed.

### SUMMARY

One feature of the present invention provides a system for automatically shutting off an appliance. The systems includes one or more detector modules configured to emit a signal upon an occurrence of an event, the signal in the form of sound waves; a data transceiver processing module configured to receive a plurality of sound waves and analyze the plurality of sound waves for a variation in frequency to determine if any of the plurality of the sound waves originate from the one or more detectors; and a control knob unit, in communication with the data transceiver processing module, adapted to be received on an operational shaft of the appliance for controlling an output source from the appliance by rotating between a first position and a second position, and where the control knob unit actuates from the first position to the second position in response to a determination of the plurality of sound waves originating from the one or more detectors.

The system may further comprise a switch board interface; and a communication device for communicating with the switch board interface; wherein the switch board interface, in response to receiving a communication from the communication device, sends a message to the control knob unit causing the control knob unit to actuate from the first position to the second position.

According to another feature, the switch board interface comprises a communication interface for receiving an access input code; a memory device for storing a list of appliance codes; and a processing circuit coupled between the communication interface and the memory device. The processing circuit may be configured to receive the access input code, the access input code provided remotely using the communication device; compare the access input code to a list of appliance codes stored in the memory device; send the message to the control knob unit causing the control knob unit to actuate from the first position to the second position disabling the output source of the appliance.

According to another feature, the control knob unit comprises a housing; a base panel connected to the housing by a pair of elongated members; a rotating rod integrally connected to and extending outwardly from the housing through the base panel at a first end and attached to the operational shaft of the appliance at a second end, the second opposite the first end; and a handle integrally connected to and extending outwardly from the housing for manually rotating the control knob unit.

According to another feature, the control knob unit may further comprise a spring encircling the rotating rod, wherein turning the housing clockwise causes the rotating rod to turn clockwise tightening the coils of the spring and where turning the housing counter clockwise causes the rotating rod to turn counter clockwise loosening the coils of the spring.

According to another feature, the control knob unit may further comprise a sprocket, having a plurality of teeth, connected to the housing; a locking mechanism engaged with the sprocket for rotating the knob control unit between a plurality of positions. The locking mechanism may comprise a mechanism housing; a latching rod slidably disposed within the mechanism housing and movable between a first position and a second position, wherein the latching rod engages the plurality of teeth of the sprocket when moved from the first position to the second position causing the sprocket to rotate; a locking spring surrounding the latching rod and adapted to move the latching rod between the first and second positions; and a solenoid coil surrounding the locking spring and rotating, where an electrical current applied to the solenoid coil energizes the solenoid coil generating a magnetic field biasing the latching rod between the first and second positions.

According to another feature, the control knob unit may further comprise a motorized locking mechanism. The motorized locking mechanism may comprise a rotating wheel rotatably engaged with the housing of the control knob unit; a motor; and a belt surrounding the rotating wheel and motor; wherein when energy is delivered to the motor, the motor causes the belt to rotate which in turn rotates the rotating wheel.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 is a functional diagram of a wireless system for automating the operation of a remote control knob unit, according to one embodiment.

FIG. 2 is a functional diagram of a wired system for automating the operation of a control knob unit, according to one embodiment.

FIG. 3 illustrates a cross-sectional view of a remote control knob unit having a solenoid locking mechanism, according to one embodiment.

FIG. 4 illustrates a cross-sectional view of a remote control knob unit having a motorized locking mechanism, according to one embodiment.

FIG. 5 illustrates a cross-sectional view of a remote control knob unit having a wireless receiver module, according to one embodiment.

FIG. 6 illustrates a cross-sectional view of a remote control knob unit, according to one embodiment.

FIG. 7 illustrates a top plan view of a remote control knob unit with the handle cover removed, according to one embodiment.

FIG. 8 illustrates an exploded plan view of a remote control knob unit, according to one embodiment.

FIG. 9 illustrates an exploded plan view of a motorized remote control knob unit, according to one embodiment.

FIG. 10 is another functional diagram of a remote shut-off system for remotely controlling the operation of a knob control unit for an appliance, according to one embodiment.

FIG. 11 illustrates a functional block diagram of the internal structure of the telephone switch interface board of FIG. 10.

FIG. 12 illustrates a functional block diagram of the internal structure of a data transceiver processing module, according to one embodiment.

FIG. 13 illustrates one example of a vibration switch for disabling appliances in the event of an earthquake.

FIG. 14 illustrates one example of a flood control switch for disabling an appliance or other device.

FIG. 15 is a functional block diagram of one example of a wireless sound wave valve having a reset switch, according to one embodiment.

FIG. 16 illustrates a schematic diagram of the sound wave valve of FIG. 15.

FIG. 17A illustrates a short wavelength sound wave having a high pitch or high frequency.

FIG. 17B illustrates a long wavelength sound wave having a low pitch or low frequency.

FIG. 17C illustrates a sound wave in the form of noise.

FIG. 17D illustrates a mixture of sound waves in the form of musical tones.

FIG. 17E illustrates a sound wave with a Doppler Effect.

FIG. 17F illustrates the characteristics of a stationary high frequency sound wave.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may not be shown detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data. Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

In the following description, certain terminology is used to describe certain features of one or more embodiments of the invention. The term “appliance” refers to any type of electrical and/or mechanical device having a control knob unit which accomplishes some household function, such as cooking, cleaning and entertaining. An appliance includes, but not limited to, a stove, oven, fryer, barbeque, clothes dryer, washing machine, air conditioner, television and radio. The term “event” refers to any type of emergency or developing emergency including, but not limited to, the detection of smoke, fire, heat, carbon monoxide and gas. The terms “energy source” and “energy” refer to any source of powering an appliance or other device including, but not limited to gas and electricity. The terms “control knob”, “control knob unit” and “knob” refer to any type of rotating dial or device for adjusting control settings on an appliance or other device. The term “control settings” may refer to the flow of electricity or gas to an appliance, a timer, etc. The terms “detector” and “detector module” refer a device for detecting the presence of hazardous environmental conditions, including, but not limited to, smoke, gas, carbon monoxide gas, natural gas, propane, fire, flames, and heat, as well as non-environmental hazardous conditions, such as motion.

According to one embodiment, a system and method for automatically rotating a control knob unit on an appliance or other device to an Off position upon the occurrence of a safety event is provided. For example an accidental fire resulting from unattended cooking.

The control knob unit may be secured to and engaged with an operational shaft on the appliance which controls the flow of gas or power to the appliance. That is, that is rotating the knob in a clockwise direction may close a gas valve or power supply control switch preventing gas and/or power to be provided to the appliance while rotating the knob in a counter clockwise direction may open a gas valve or power supply control switch providing gas and/or power to the appliance. For example, when a control knob for a burner of a gas stove is rotated in a counter clockwise direction, the gas valve may open providing gas to the burner and as a result generating a flame for cooking.

The system may include one or more detectors (or detector modules) that are configured to emit a signal upon an occurrence of the event, such as a fire, which may be an early indication of a developing emergency. The signal may be in the form of an audible alert, such as sound (or sound waves). A data transceiver processing module may receive a plurality of sound waves and analyze the plurality of sound waves for a variation in frequency (or Doppler Effect) to determine if any of the sound waves originate from the one or more detector modules. As sound waves emanating from detector modules have the characteristics of a stationary high frequency, it is known that sound waves having a variation in frequency are not emanating from the detector modules.

According to one embodiment, upon the determination of sound waves originating from a detector module, the remote control knob unit may be activated and rotated in a clockwise direction, via a controlled magnetic coil motor, to close the gas valve and/or power supply switch.

The system may utilize radio frequency (RF) modules for communicating with the remote control knob unit. The system may be programmable to different frequencies allowing for multiple control knob units to be controlled remotely. The system may also utilize Bluetooth®, 802.11 (i.e., Wi-Fi®) and/or an infra-red (IR) means to communicate with the remote control knob units.

According to another embodiment, a remote control knob unit for an appliance may be remotely activated based on programming of an allotted time to maintain the knob in an open (or On) position or a closed (or Off) position. The remote control knob unit may be programmed using a personal computing device directly or wirelessly connected to the system. One or more programs may be stored in a data transceiver processing module which is in communication with the remote control knob unit. The data transceiver processing module may provide for the distribution of energy from a power source to turn on other devices, such as lights or an exhaust fan.

According to yet another embodiment, when the control knob is activated, an audio alert (sound) and/or flashing of an illumination device, such as a light emitting diode, on the control knob may occur for a pre-determined time. Alternatively, the audio alert and/or flashing of the illumination device may continually occur until manually turned Off.

According to yet another embodiment, the control knob unit may have a safety locking mechanism to prevent the manual rotation of the control knob unit in a clockwise or counter clockwise direction upon the detection of an event. The safety locking mechanism may be overridden by pushing in the control knob unit to disengage a pin unlocking the control knob unit.

According to yet another embodiment, the remote control knob unit may have a display, such as a liquid crystal display, for displaying the time, date, temperature and status of the remote control knob (i.e. whether the knob is in an open or closed position).

According to yet another embodiment, the system may include a monitoring device that can be programmed to determine the number of appliances currently being used and to set an allocated time for the use of each appliance. The monitoring device may have an electronic igniter for gas appliances that is synchronized with the knob control unit. The monitoring device may also limit the flow of necessary energy to meet the determined cooking temperature needed during the operation. When excessive temperature is detected, the remote control knobs may rotate counter clockwise to reduce the distribution of energy.

The remote control knob unit may include a data encoder to set the cooking time and automatically cut off the source of energy by automatically rotating the knobs to an Off position in a predetermined time encoded such as time allotted by the operator to cook, for example, rice, meat, fish and vegetables. Sounds, alarms, beeps and/or music, for example, can be programmed as an indicator signal when encoded time is attained. Other indicators or signals may include a strobe light, LED flasher and lights.

According to yet another embodiment, the system may include a Passive Infra-Red (PIR) device to detect human heat with motion and override the system communication with the appliances knob to prevent the control knob unit to turn off when human heat and motion is detected within the location.

According to yet another embodiment, in addition to being powered by a power supply, the remote control knob may also include a battery backup embedded within the control knob unit.

### Wireless Automation of Control Knob

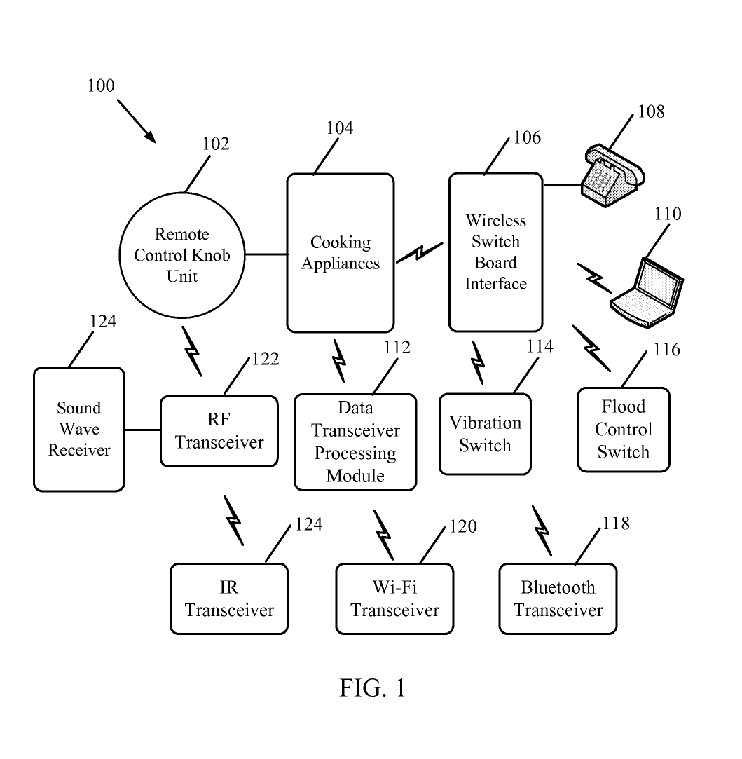

FIG. 1 is a functional diagram of a wireless system 100 for automating the operation of a remote control knob unit, according to one embodiment. As shown, a remote control knob unit 102 may be utilized to remotely operate a device, such as a cooking appliance 104. The remote control knob unit 102 may include a control knob directly engaged with the operational shaft of the cooking appliance 104, the operational shaft of the appliance for opening and closing a gas control valve, a thermal control switch and/or power supply used to operate the appliance 104.

According to one embodiment, a wireless switchboard module 106 may be communicatively coupled between the remote control knob unit 102 on the appliance 104 and a communication device 108. The communication device 108 may be wired or wirelessly connected to the wireless switchboard module 106 and may be, for example, a telephone or mobile device. The communication device 108 may be utilized to activate the switchboard module 106 causing the switchboard module 106 to transmit a signal to the remote control knob unit 102 which in turn may automatically turn or rotate the knob to the Off position. Furthermore, a personal computing device 110, such as a laptop or desktop, may be utilized to transmit a signal to the remote control knob unit 102 to automatically turn or rotate the control knob unit to the Off position. The signal may be transmitted in real time, on the fly, or the signal may be pre-programmed, using the personal computing device 110, for transmission upon the occurrence of an event. The personal computing device 110 may be wired or wirelessly connected to a data transceiver processing module 112 for storing one or more programs for turning or rotating the control knob unit. The programs may identify a specific time or time frame in which to rotate the control knob unit(s) from an open position to a closed position or from a closed position to an open position, and a desired cooking temperature.

A vibration switch 114 and a flood control switch 116 may be wirelessly in communication with the remote control knob unit 102. The vibration switch 114 may be utilized to determine the occurrence of a significant earthquake while the flood control switch 116 may be used to detect a large amount of water. In the event of an earthquake or flood, the vibration switch 114 and flood control switch 116, respectively, may transmit a signal to the remote control knob unit 102 for automatically turning or rotating the knob to the Off position. Earthquakes may trigger a fire and floods may trigger gas leaks that can create poisonous air. The vibration and floods control switches can trigger control knob unit to rotate clockwise to a closed position.

Alternatively, the vibration switch 114 and flood control switch 116, respectively, may transmit a signal to the data transceiver processing module 112 which may then instruct the remote control knob unit 102 to automatically turn or rotate the control knob unit to the Off position. Earthquakes may trigger a fire and floods may trigger gas leaks that can create poisonous air. The vibration and floods control switches can trigger control knob unit to rotate clockwise to a closed position.

The system 100 may also include a Bluetooth® transceiver 118, an 802.11 (i.e., Wi-Fi®) transceiver 120, a Radio Frequency (RF) transceiver 122 and/or an infra-red (IR) transceiver 124 for communicating with the remote control knob unit 102. These transceivers may be installed in detectors (or detector modules), including but not limited to, fire alarms, smoke alarms, and carbon monoxide detectors and send a signal to the remote control knob unit 102 to trigger the knob to turn or rotate to the Off position.

A sound wave receiver 126 may be in communication with the RF transceiver 122 which receives and transmits sound waves to the data transceiver processing module 112. The data transceiver processing module 112 may be used to detect any high pitch sounds or alarms. Upon detecting a high pitch sound or alarm, from a smoke or fire alarm for example, the data transceiver processing module 112 may transmit a signal to the remote control knob unit 102 to automatically turn or rotate the knob to the Off position.

### Wired Automation of Control Knob

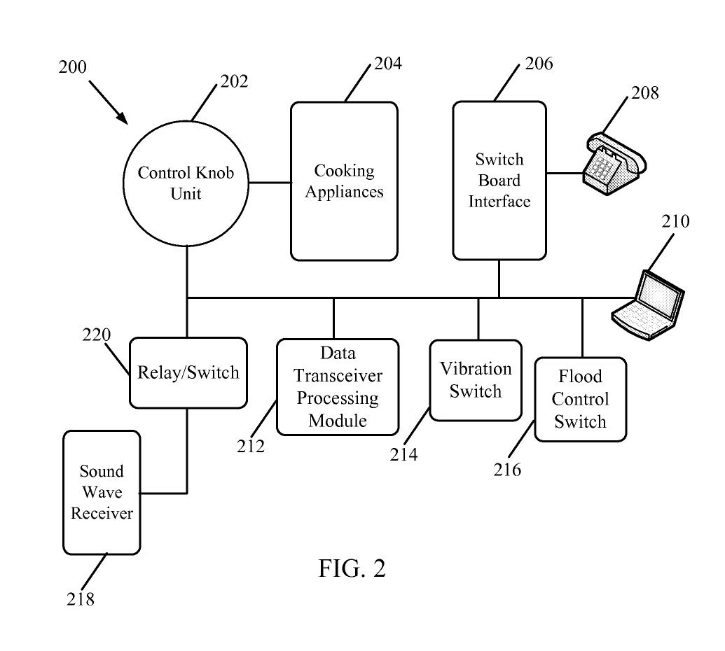

FIG. 2 is a functional diagram of a wired system 200 for automating the operation of a control knob unit, according to one embodiment. As shown, a control knob unit 202 may be utilized to operate a device, such as a cooking appliance 204. The control knob unit 202 may include a control knob directly engaged with the operational shaft of the cooking appliance 204, the operational shaft of the appliance for opening and closing a gas control valve, a thermal control switch and/or power supply used to operate the appliance 204.

According to one embodiment, a switchboard module 206 may be communicatively connected between the control knob unit 202 on the appliance 204 and a communication device 208. The communication device 208 may be connected to the switchboard module 206 and may be, for example, a telephone or mobile device. The communication device 208 may be utilized to activate the switchboard module 206 which in turn may cause the switchboard module 206 to transmit a signal to the control knob unit 202 to automatically turn or rotate the knob to the Off position. Furthermore, a personal computing device 210, such as a laptop or desktop, may be utilized to transmit a signal to the control knob unit 202 to automatically turn or rotate the knob to the Off position. The signal may be transmitted in real time, on the fly, or the signal may be pre-programmed, using the personal computing device 210, for transmission upon the occurrence of an event. The personal computing device 210 may be wired or wirelessly connected to a data transceiver processing module 212 for storing one or more programs for turning or rotating the control knob. The programs may identify a specific time or time frame in which to rotate the knob(s) from an open position to a closed position or from a closed position to an open position, and a desired cooking temperature.

A vibration switch 214 and a flood control switch 216 may be in communication with the remote control know unit 202. The vibration switch 214 may be utilized to determine the occurrence of a significant earthquake while the flood control switch 216 may be used to detect a large amount of water. In the event of an earthquake or flood, the vibration switch 214 and flood control switch 216, respectively, may transmit a signal to the control knob unit 202 for automatically turning or rotating the knob to the Off position.

Alternatively, the vibration switch 214 and the flood control switch 216 may transmit may transmit a signal to the data transceiver processing module 212 which may then instruct the remote control knob unit 202 to automatically turn or rotate the control knob unit to the Off position. Earthquakes may trigger a fire and floods may trigger gas leaks that can create poisonous air. The vibration and floods control switches can trigger control knob unit to rotate clockwise to a closed position.

A sound wave receiver 218 may be connected to the control knob unit via a relay/switch 220 and used to detect any high pitch sounds or alarms. Upon detecting a high pitch sound or alarm, from a smoke or fire alarm for example, the sound wave receiver 218 may trigger the relay/switch 220 to move from open position to a closed position which in turn causes the control knob unit 202 to automatically turn or rotate the knob to the Off position.

### Remote Control Knob Having Solenoid Locking Mechanism

FIG. 3 illustrates a cross-sectional view of a remote control knob unit 300 having a solenoid locking mechanism, according to one embodiment. As shown, the remote control knob 300 may include a housing (or chassis) 302 having a mounting aperture 303 shaped to accept an operational shaft, for example a valve or thermal control shaft, of an appliance. Included in the mounting aperture 303 are pin holes 301 for holding or locking the operational shaft of the application onto the remote control knob unit 300.

The remote control knob unit 300 may further include a solenoid locking mechanism 314 engaged with a sprocket 303, connected to the housing 302, for rotating the knob control unit 300 between a plurality of positions. The solenoid locking mechanism may include a latching rod 304 slidably disposed within a mechanism housing 312 and movable between a first position and a second position wherein the latching rod 304 engages the teeth of the sprocket 303 when moved from the first position to the second position causing the sprocket 303 to rotate.

A spring 310 may surround the latching rod 304 and may be used to move the latching rod 304 between the first and second positions. A solenoid coil 305 may surround the latching rod 304 and the spring 310. The solenoid coil 305 may be energized, by the application of an electrical current generating a magnetic field to bias the latching rod 304 between the first and second positions. When energized, the latching rod 304 may be pulled up to the level of a solenoid cap 306, secured to an outer surface of the solenoid coil 305, unlocking the sprocket 303 allowing the sprocket 303 to freely rotate in a counter-clockwise direction moving the knob 300 to an Off position. When the source of energy is removed and the solenoid coil is un-energized, the latching rod 304 may be forced down by the spring 310 preventing the sprocket from rotating. The source of energy to the solenoid coil 305 may be provided by positive and negative power lines 307, 307 attached to a main power line connector 309. According to one example, the main power line connector 309 may be provided by the appliance.

### Remote Control Knob Having Motorized Locking Mechanism

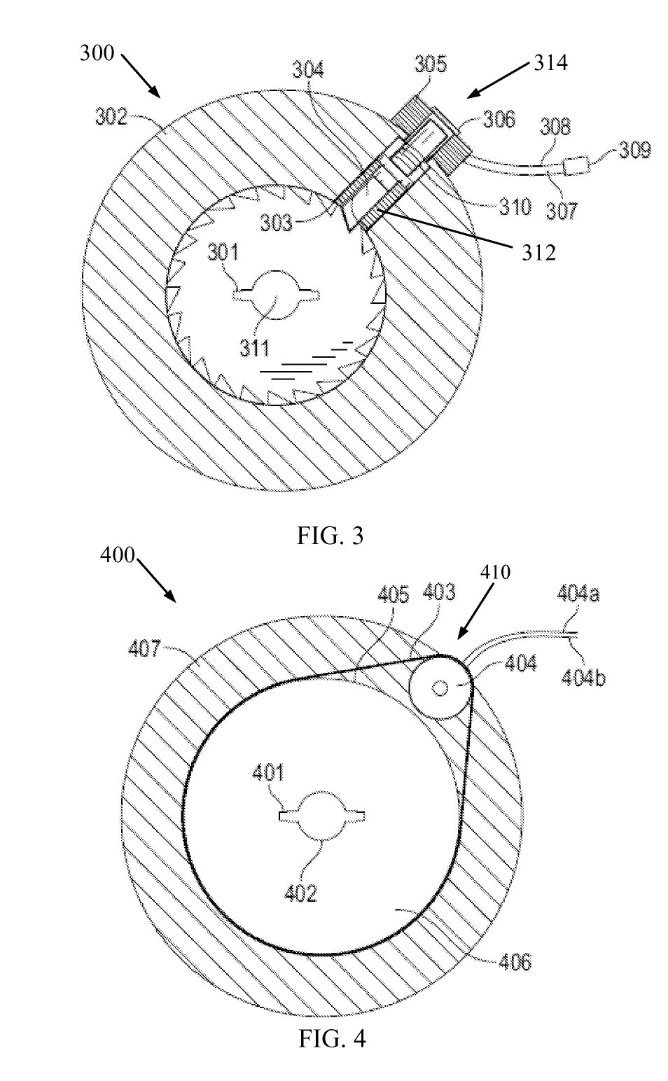

FIG. 4 illustrates a cross-sectional view of a remote control knob unit 400 having a motorized locking mechanism 410, according to one embodiment. As shown, the remote control knob unit 400 may include a housing (or chassis) 407 having a mounting aperture 402 shaped to accept an operational shaft, for example a valve or thermal control shaft, of an appliance. Included in the mounting aperture 402 are pin holes 401 for holding or locking the operational shaft of the application onto the remote control knob unit 400.

The motorized locking mechanism 410 may include a rotating wheel 406 rotatably engaged with the housing (chassis) 407. A belt 403 may surround the rotating wheel 406 and a motor 404. To hold the belt 403 to the rotating wheel 406, the belt 403 may be placed within a groove 405 located around the circumference of the rotating wheel 406. When controlled energy is delivered to the motor 404, the motor 404 rotates causing the belt 403 to rotate which in turn rotates the rotating wheel 406. The source of energy to the motor 404 may be provided by positive and negative power lines 404a, 404b attached to a main power line connector (not shown). According to one example, the main power line connector may be provided by the appliance.

### Remote Control Knob Having Wireless Receiver Module

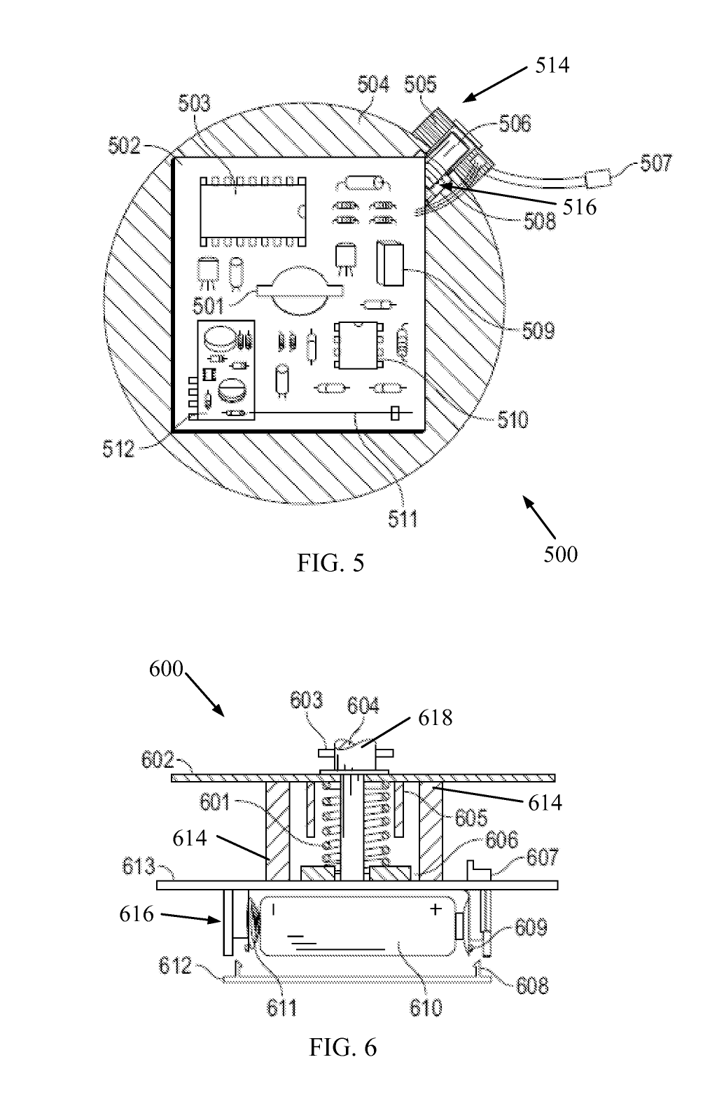

FIG. 5 illustrates a cross-sectional view of a remote control knob unit 500 having a wireless receiver module 512, according to one embodiment. As shown, a printed circuit board 502 may be mounted to a housing (chassis) 504 of the remote control knob unit 500 and have a shaft chamber 501, the shaft chamber connected to an elongated operational shaft, for example a gas valve or thermal control shaft, of an appliance. The shaft chamber 501 may be connected to the ground of the printed circuit board 502 and wireless receiver module 512 located on the printed circuit board 502.

Located on the printed circuit board is a decoder 503 compatible with an encoder of a transmitter module on a detector module (not shown) or a transceiver as described above with reference to FIG. 1. The decoder 503 may transmit instructions to the wireless receiver module 512. The decoder 503, when activated, may energize a relay 509, located on the printed circuit board 502, providing power to a solenoid coil 505 of a solenoid locking mechanism 514, secured to the housing 504 of the remote control unit, through a power connector 507. According to one example, the power connector 507 may be provided by the appliance.

The solenoid locking mechanism 514 may include a latching rod 506 slidably disposed within a housing 516 of the mechanism 514 and movable between a first position and a second position. A spring 508 may be used to move the latching rod 506 between the first and second positions. The solenoid coil 505 may surround the latching rod 506 and the spring 508. The solenoid coil 505 may be energized, by the application of an electrical current generating a magnetic field to bias the latching rod 506 between the first and second positions. When energized, the latching rod 506 may be pulled up unlocking the control knob unit 500 allowing the control knob unit 500 to freely rotate in a counter-clockwise direction to an Off position. When the source of energy is removed and the solenoid coil 505 is un-energized, the spring 508 may push down on the latching rod 506 locking the control knob unit 500 in place and preventing it from rotating. Unlike the motorized control knob unit of FIG. 4, the control knob unit 500 may be rotated a number of turns to position the gas valve shaft to a determined volume of gas to release or the thermal control shaft to a determined temperature that is desired for the cooking appliance. A locking mechanism may not be utilized with the remote control knob unit 500.

The wireless receiver module 512 may receive a signal from a transmitter (not shown) through a specified frequency, such as 315-433 MHz and communicate with the decoder 503 to power on the relay 509. A receiver module antenna 511 may be secured to the printed circuit board 502 to avoid obstruction to when rotating the control knob unit 500. A pre-determined time for rotating the control knob unit 500 may be programmed into the wireless receiver module 512 which can be encoded to a timer 510. At the pre-programmed times, the control knob unit 500 may to rotated to its determined volume and/or temperature.

### Remote Control Knob Unit

FIG. 6 illustrates a cross-sectional view of a remote control knob unit 600, according to one embodiment. As shown, the knob 600 may have a housing (chassis) 613 integrally connected to a base panel 602 by a pair of elongated members 614. The housing 613 may have a handle 616 extending outwardly for manually rotating the housing 613 of the remote control knob unit 600. The handle 616 may be integrally connected to the housing 613 or detachable secured to the housing via a connector 607.

An rotating rod 604 may be integrally connected to and extend outwardly from the housing 613 through the base panel 602. A spring 601 may encircle the rotating rod 604. Turning the housing 613 clockwise causes the rotating rod 604 to turn clockwise tightening the coils of the spring 601. Conversely, turning the housing 613 counter clockwise causes the rotating rod 604 to turn counter clockwise loosening the coils of the spring 601.

An attachment end 618 of the rotating rod 604, extending outwardly from the base panel 602, may be adapted for receiving an elongated operational shaft, for example a gas valve or thermal control shaft, of an appliance. A locking pin 603 may extend through the attachment end of the rotating rod 604 and latch or hold the rotating 604 to the elongated operational shaft of an appliance.

Stoppers 605 may be located on the side of the spring 605 to limit the pressure applied when twisting the housing 613 of the knob control unit 600. A blocking plate 606 may be located on the spring 601 to enable the spring 605 to be twisted and energized to create a force to rotate counter clockwise and to prevent the spring 605 from rotating.

The remote control knob unit 600 may utilize the locking mechanism 314, as illustrated in FIG. 3, to lock the remote control unit 600 in an open of closed position. The locking mechanism 314 may be powered by a main power line connector from the appliance, as described above. Alternatively, the locking mechanism may be powered by a battery 602 located in the handle 616 of the housing 613. The battery 610 may energize the solenoid coil 305 of the locking mechanism 314 to unlock the control knob unit 600 allowing the control knob unit 600 to rotate. According to one embodiment, the battery 610, which may be between 6 and 18 VDC, may be located within the handle 616.

The handle 616 may include a cavity for receiving the battery 610 and a handle cover 612 for covering the cavity. The handle cover secured to the cavity by a pair of latches 608. Integrally connected to housing 613 and the inner sides of the cavity may be a positive terminal 609 and a ground terminal 611 for contacting the positive and negative terminals of the battery 610, respectively. The positive terminal 609 may be connected to the connector 607 and the ground terminal 611 may be connected to the housing 613. The locking mechanism 314 may be connected to the connector 607 and chassis 613 providing power to the locking mechanism 314.

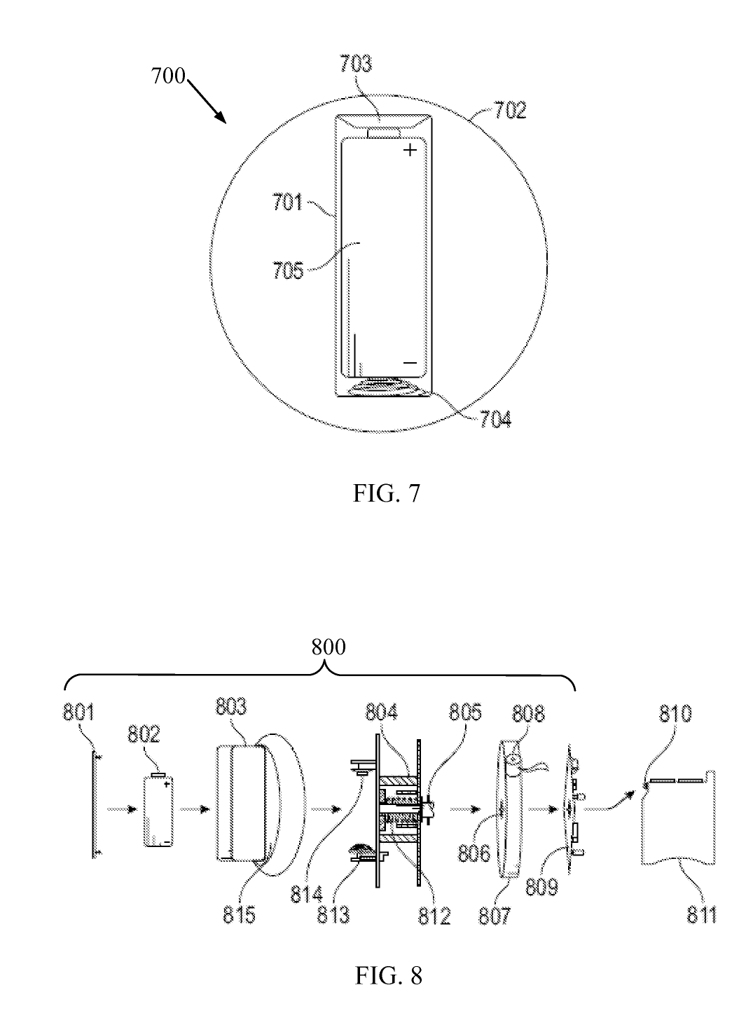

FIG. 7 illustrates a top plan view of a remote control knob unit with the handle cover removed, according to one embodiment. As shown, the remote control knob unit 700 may include a handle 701 secured to a housing (chassis) 702. The handle cover has been removed to illustrate the battery 705 located within a cavity of the handle 701. A positive terminal 703 and a ground terminal 704 may be located on opposite walls of the cavity. When placing the battery in the cavity, the positive terminal 703 and the ground terminal 704 of the cavity are placed in contact with the positive and negative terminals of the battery 705.

FIG. 8 illustrates an exploded plan view of a remote control knob unit 800, according to one embodiment. As shown, a housing 815 may include a handle 803 having a cavity for insertion of a battery 802. Once the battery has been inserted into the cavity, a handle cover 801 may be placed over the cavity. As the handle 803 extends outwardly from the housing 815, it may be utilized as a handle to manually rotate the control knob unit 800.

According to one embodiment, a positive terminal 814 and a negative terminal 813 may be integrally connected to the housing 816 and the housing may be placed over the base panel 804. The base panel 804 may protect the spring 812 for retaining the spring 812 in an intact and standard position. An attachment end of the rotating rod may be inserted into a hole 806 in a sprocket (or sprocket assembly) 807 and secured to the sprocket 807 by a lock pin 805, the lock pin 805 preventing the rotating rod from disengaging from the hole 806.

The assembled remote control knob unit 800 may then be placed on the shaft of a gas valve or thermal control shaft 810 of an appliance 811, such as a stove. The remote control knob unit 800 may be universally compatible with control knobs of various appliances.

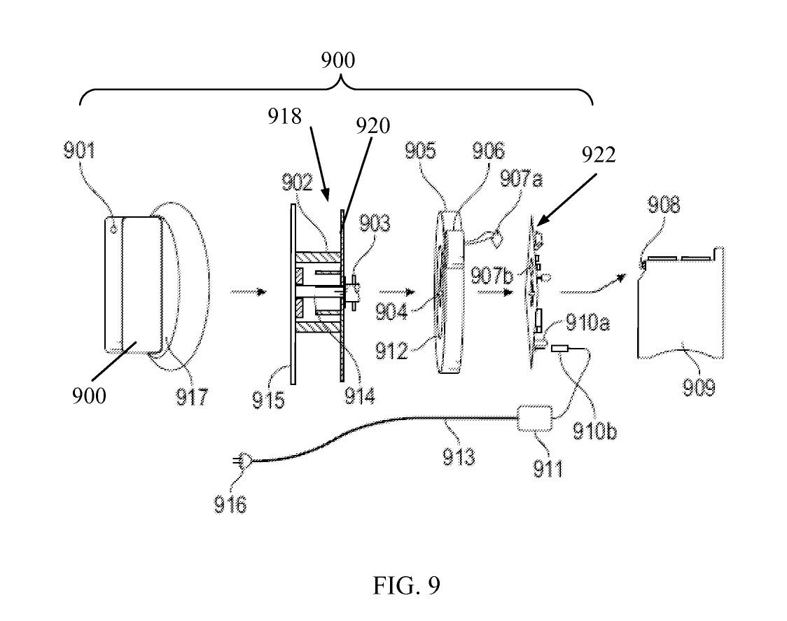

FIG. 9 illustrates an exploded plan view of a motorized remote control knob unit 900, according to one embodiment. As shown, the remote control knob unit 900 may include a housing 917 having a handle 918 extending outwardly; the handle 918 may be utilized to manually rotate the knob control unit 900. An indicator light 901, such as a light emitting diode, may be located in the handle 918 of the housing 917. When the indicator light 901 is illuminated, the system may be powered On. Conversely, when the indicator light 901 is not illuminated, the system may be powered Off.

The housing 917 may be placed over a panel assembly 918 comprising a housing panel 915 and a base panel 920 separate by a pair of elongated members 902. A rotating rod 914 may be integrally connected to and extend outwardly from the housing panel 915 through the base panel 920. An attachment end of the rotating rod 914 may be inserted into a hole 904 in a motorized assembly 905 and secured to the motorized assembly 905 by a lock pin 903, the lock pin 903 preventing the rotating rod 914 from disengaging from the hole 904 by twisting the attachment end of the rotating rod 914 with the lock pin 903.

The motorized assembly 905 may be rotatably engaged with the housing 917. A belt 912 may surround a rotating wheel and a motor 906. The motor may be energized by a wireless receiver module (or interface) 922 through a motor wiring connector 907a and connected to a female connector 907b of the receiver interface. The rotating wheel or center shaft may be rotated by the belt 912 run by the motor 906. The energy distributed to the motor 906 may be controlled by the receiver module 922 depending on the number of twists that are allotted or programmed.

The control knob unit 900 may be powered by an AC to DC converter 911 having a power output 910b directly connected to a power DC connector 910a which provides energy to the receiver module 922. The source of power supply is generated from a plug 916 inserted into an outlet and attached to the connector by a power cord 913.

The assembled remote control knob unit 900 may then be placed on the shaft of a gas valve or thermal control shaft 908 of an appliance 909, such as a stove. The remote control knob unit 900 may be universally compatible with control knobs of various appliances.

### Switch Interface Board

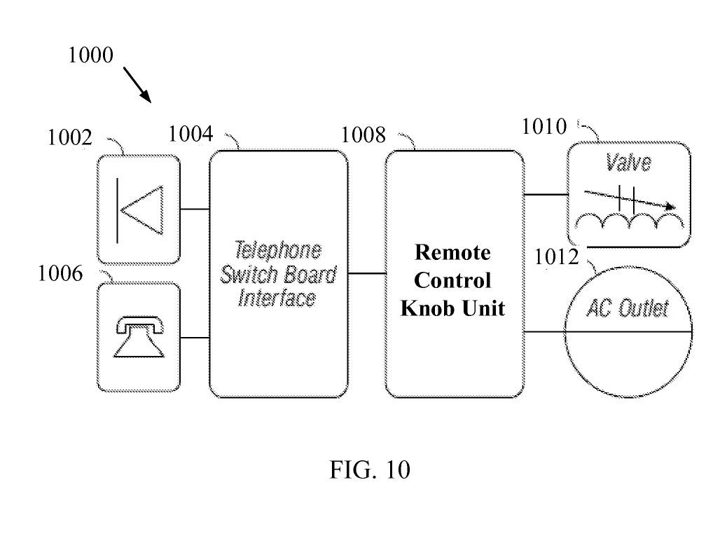

FIG. 10 is another functional diagram of a remote shut-off system for remotely controlling the operation of a knob control unit for an appliance, according to one embodiment. As shown, a main telephone line 1002 may be an input into a telephone switch board interface 1004. Upon receiving a call, the telephone switch board interface 1004 may automatically connect the call to a receiver 1006, such as a telephone. If the telephone is not answered within a pre-determined number of rings, the telephone switch board interface 1004 may request a code from the caller, the code allowing the caller to disable the flow of energy to the one or more appliances or other devices by rotation of the control knob unit. The pre-determined number of rings may be pre-programmed into the system, or the user or caller may set the number of unanswered rings to occur before the code is requested.

Upon entering a code, the code is compared to the value stored in memory. If the entered code and the stored code match, the telephone switch board interface 1004 may cause a remote control knob unit 1006 to rotate from an open position to a closed position or from a closed position to an open position. When the control knob unit is in the closed position, a valve 1010, such as a gas valve, may be closed preventing gas from reaching the appliance. Additionally, when the control knob unit is in the open position, electrical power 1012 to the appliance may be cut off or interrupted.

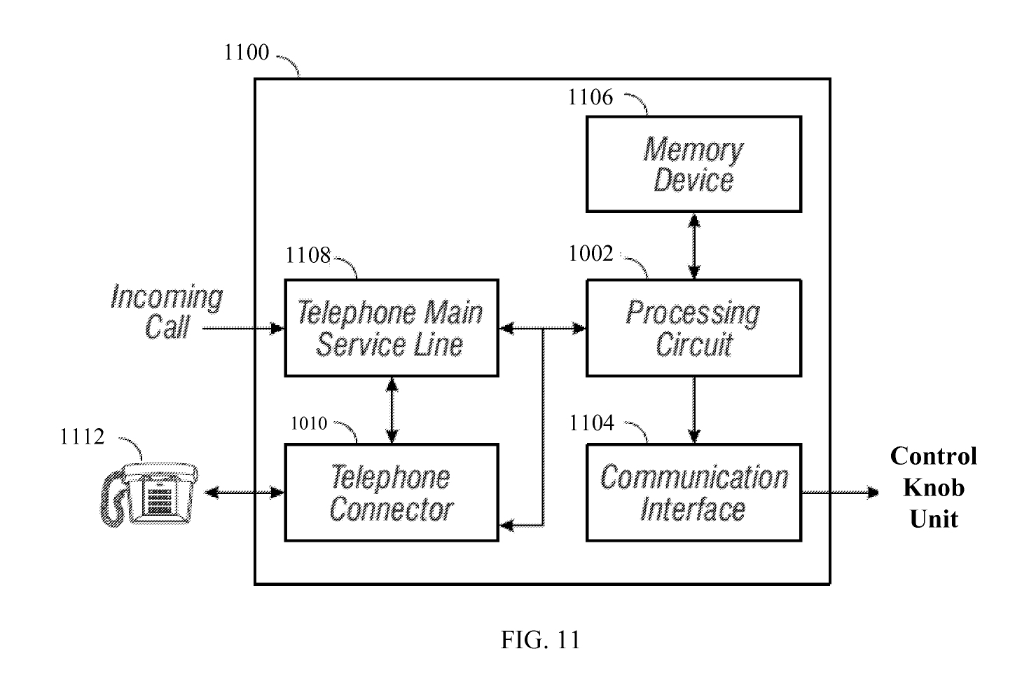

FIG. 11 illustrates a functional block diagram of the internal structure of the telephone switch interface board of FIG. 10. The telephone switch interface board 1100 may include a processing circuit 1102 (e.g., processor, processing module, etc.) coupled to a communication interface 1104 to communicate over a wired and wireless network with a control knob unit, and a memory device 1106 to store codes associated with each appliance allowing the user to turn off a specific appliance or multiple appliances. The processing circuit 1102 may be connected to a telephone main service line 1108 for receiving incoming calls and a telephone connector 1110 in communication with a telephone 1112.

### Data Transceiver Processing Module

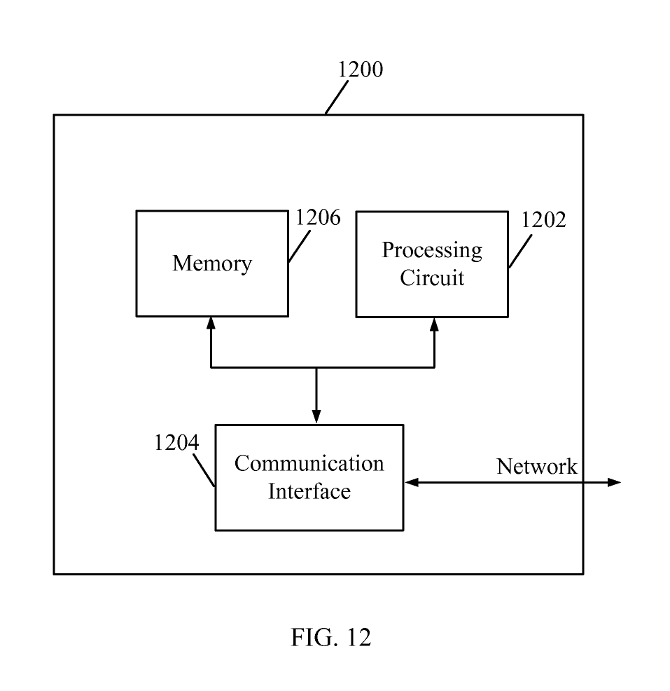

FIG. 12 illustrates a functional block diagram of the internal structure of a data transceiver processing module 1200, according to one embodiment. The data transceiver processing module 1200 may include a processing circuit 1202 (e.g., processor, processing module, etc.) coupled to a communication interface 1204 to communicate over a wired and wireless network with a remote control knob unit, a detector module, telephone switchboard module, a computing device and a memory device 1206 to store codes associated with each appliance allowing the user to turn off a specific appliance or multiple appliances. The memory device 1206 may also store one or more programs. Programs may specify a specific time or time frame in which to rotate the control unit knob(s) from an open position to a closed position or from a closed position to an open position, and a desired cooking temperature. The data transceiver processing module may also receive sound waves and determine if the sound waves original from a detector module. If the sound waves are received from the detector module, the data transceiver processing module 1200 causes the control knob unit to actuate from a first (or On position) to a second (or Off) position.

Detector modules may include, but are not limited to, environmental condition detectors for detecting hazardous environmental conditions, such as smoke detectors, gas detectors for detecting carbon monoxide gas, natural gas, propane, and other toxic gas, fire detectors, flame detectors, heat detectors, infra-red sensors, ultra-violet sensors, and combinations thereof. Detector modules may be distributed at suitable locations within a building for detecting hazardous conditions throughout the building. For example, if the building is a home, the detector means (or modules) can be located in the various rooms of the home, including the kitchen, the basement, the bedrooms, etc. The detector module can also include, but is not limited to, detectors that detect a non-environmental hazardous condition, such as motion sensors. Signals may be sent to and from detector modules using wired or wireless signals, such as voice and/or data signals or messages. The signal may be a radio frequency (RF) signal, a pulsed signal, or a simple voltage level. Additionally, the detector modules may be operatively connected to multiple receiver modules, where each receiver module is operatively coupled to a different appliance.

### Vibrational Switch

According to one embodiment, a vibration switch may be utilized to determine the occurrence of a significant earthquake. A vibration switch is a device that recognizes the amplitude of the vibration to which it is exposed and provides a response in the form of an output signal when this amplitude exceeds a predetermined threshold value. For example, in the event of a significant earthquake, the vibration switch will recognize that the amplitude of vibrations that it is measuring exceeds a threshold value and sends a signal to a valve controller or other device causing a valve located between an energy source and an appliance to close disabling the flow of energy to the appliance.

FIG. 13 illustrates one example of a vibration switch 1300 for disabling appliances in the event of an earthquake. As shown, the vibration switch 1300 may include a ball 1302 located within a housing 1301. When no vibrations are detected, the ball 1302 may connect a first line 1304 and a second line 1306 together. However, when a vibration exceeding a pre-determined threshold is detected, the ball 1302 may move to a different position within the housing causing a connection between different lines. For example, a third line 1308 and a fourth line 1310 may form a connection or the third line 1308 and the first line 1304 or the second line 1306 and the fourth line 1310 may connect. The connected lines may be used to power a relay controlling the flow of energy to an appliance, as described above. According to one embodiment, when the ball 1302 moves to different switching position, power to the relay may be interrupted which in turn disables energy or power to the appliance.

### Flood Control Switch

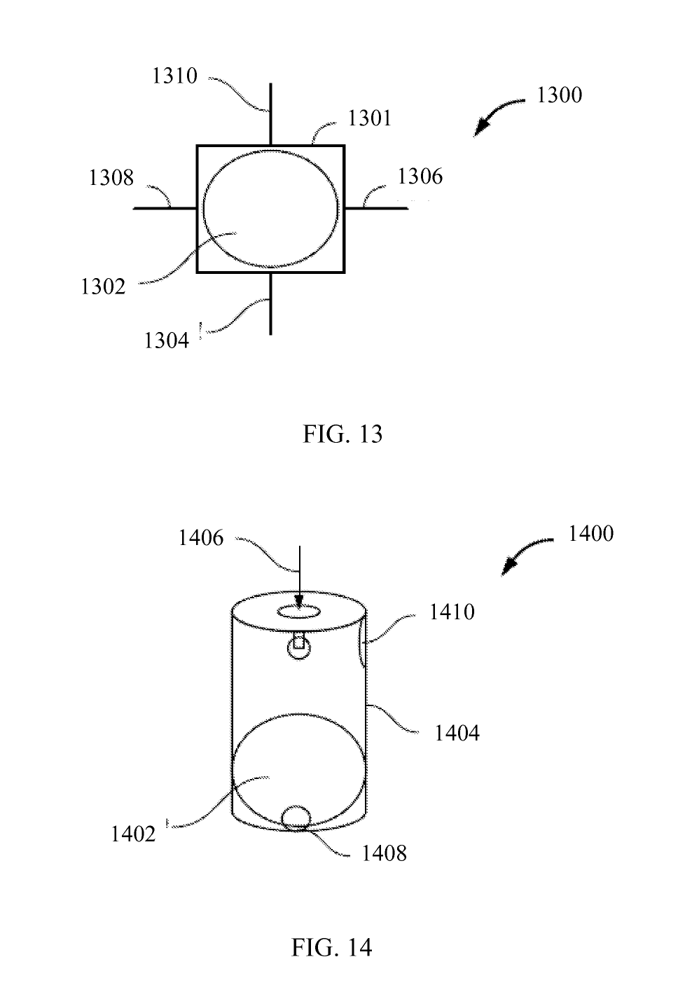

According to one embodiment, a flood control switch may be utilized to prevent the flow of energy to an appliance or other device in the event that there is excessive water present. FIG. 14 illustrates one example of a flood control switch for disabling an appliance or other device. As shown, the flood control switch 1400 may include a ball 1402 located at the center of a canister 1404 which floats to push a switch 1406. Water, or other fluid, may enter the canister 1404 through a water intake hole 1408 located on a side of the canister 1404. As water enters the canister 1404, the ball 1402 is pushed upwards. In the event of excess water, the ball may be pressed against the switch 1006 which in turn may send a signal to a valve controller causing a valve (or valve member), located between an energy source and an appliance, to close disabling the flow of energy to the appliance or other device. The flood control switch may also include a water release hole 1410 allowing water to be released from the canister 1404 if the water recedes.

### Sound Wave Receiver Valve

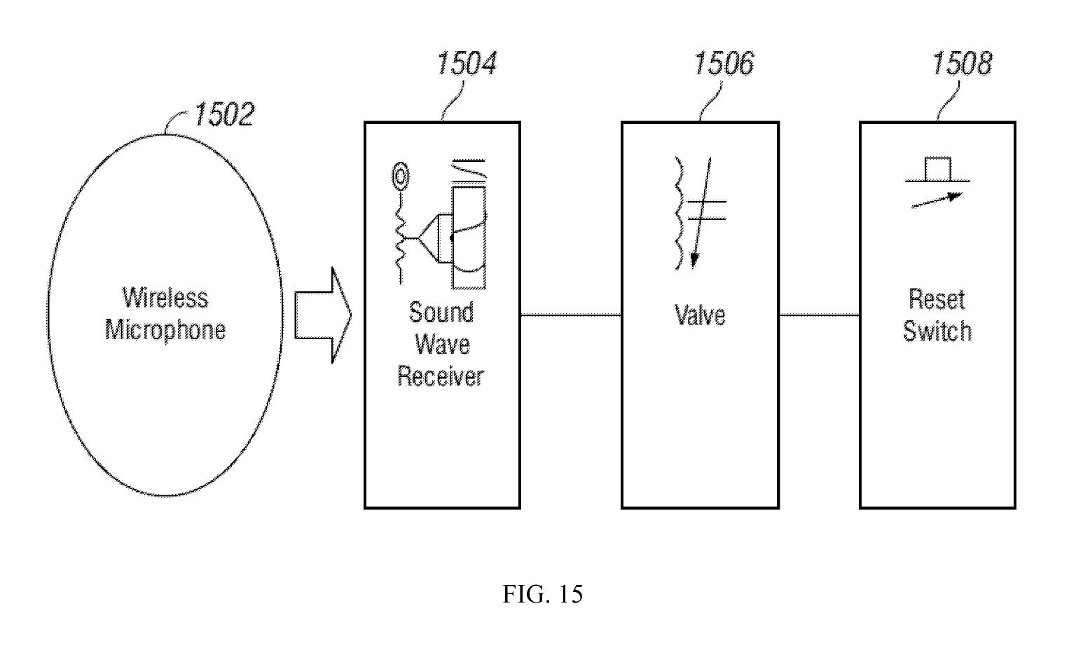

FIG. 15 is a functional block diagram of one example of a wireless sound wave valve having a reset switch, according to one embodiment of the present invention. As shown, a wireless microphone 1502 (or directional sound receiver) may receive sound waves which are provided to a sound wave receiver 1504. The sound wave receiver 1504 may determine if any of the received sound waves include any high pitch sounds or alarm.

The determination of the receipt of high pitch sound waves may trigger a single pole double throw (SPDT) relay, located within the receiver 1504, to actuate from a closed position to an open position causing power to be to cut-off or interrupted to a valve (or valve member) 1506 which regulates the flow of energy to the appliance or other device. When power to the valve (or valve member) 1506 is interrupted, a magnetic coil in the valve releases a lock rod causing the lock rod to disable or interrupt the flow of energy, such as gas, to the appliance. A push button switch 1508, operatively coupled to the valve (or valve member) 1506, may be manually pushed causing the valve to move from the closed position to the open position by re-engaging power to the valve (or valve member) 1506 and allowing energy to again flow to the appliance or other device.

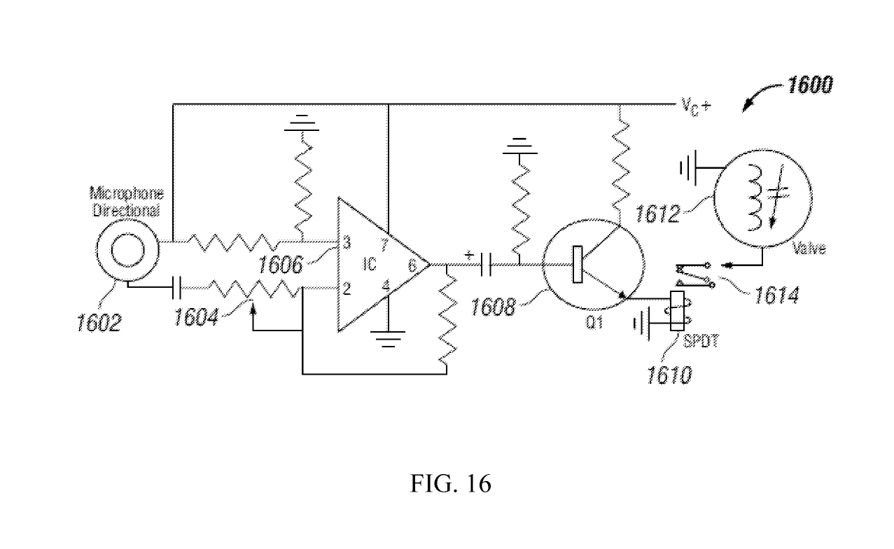

FIG. 16 illustrates a schematic diagram of the sound wave valve of FIG. 15. As shown, a directional microphone 1602 may receive sound waves, including high pitch audible sounds, which are transmitted to a trimmer resistor 1604 for filtering and controlling wave gains. The filtered sound waves may then be transmitted from the trimmer resistor (or potentiometer) 1604 to an operational amplifier 1606 for amplification. The amplified sound waves may then be transmitted to a transistor 1608 for measuring the stable frequency of the sound waves and powering on a single pole double throw (SPDT) relay 1610. If there is a variation in the frequency, or a Doppler Effect, of the sound waves, the transistor 1608 may provide power to the SPDT relay 1610 causing the SPDT relay 1610 to actuate from a closed position to an open position causing power to be to cut-off or interrupted to a valve (or valve member) 1612 causing the disconnection of the flow of energy to the appliance or other device. Conversely, when the SPDT relay 1610 is not powered-on and in the closed position, power may be supplied to the valve (or valve member) 1612 causing energy to flow to the appliance or other device.

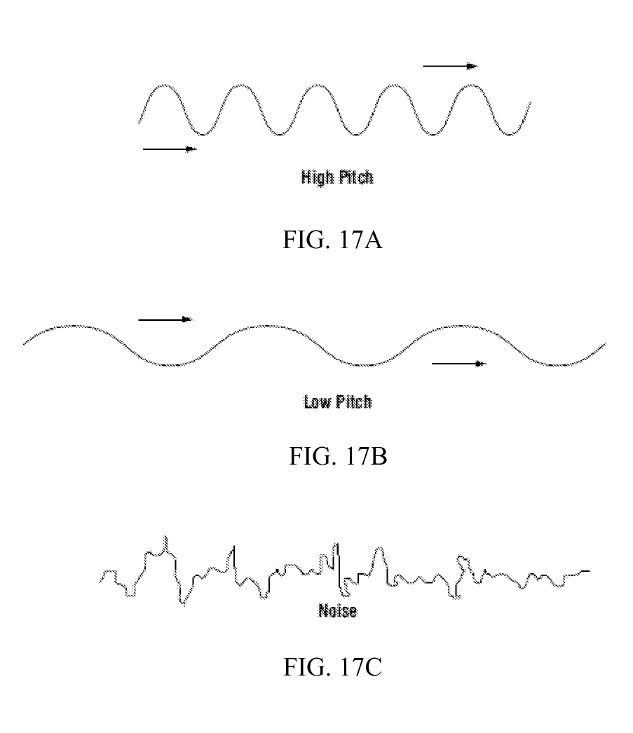

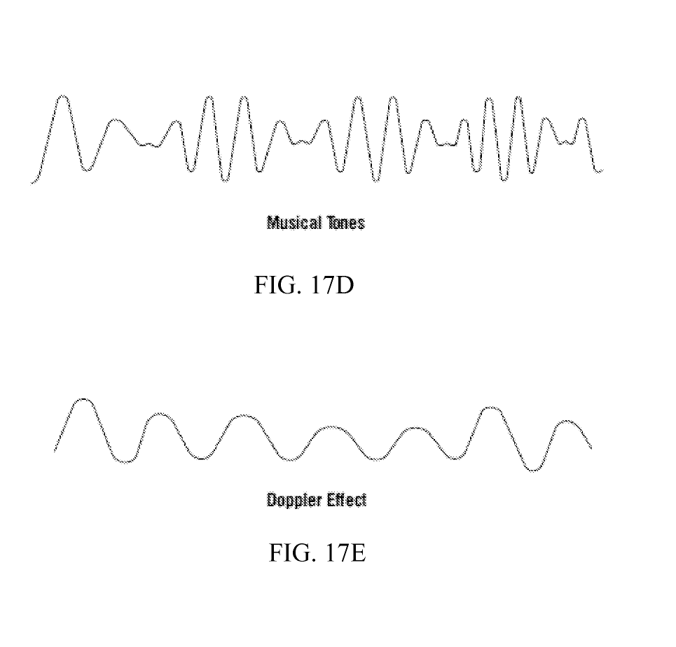

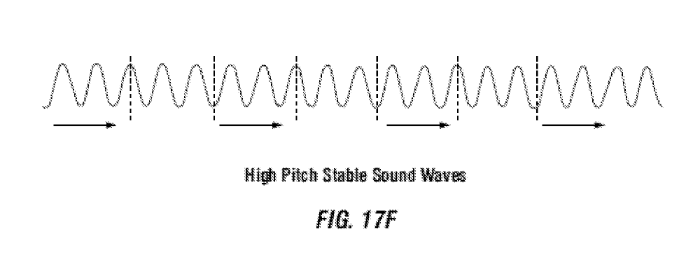

FIGS. 17A-17F illustrate various diagrams of sound waves which may be received by the sound wave receiver of FIG. 15. As discussed above, the sound wave receiver may be activated upon the receipt of a stationary high pitch (high frequency) sound wave as shown in FIG. 17A. One characteristic of stable high frequency sound waves may be that the source and receiver of the sound remain stationary so that the receiver will hear the same frequency sound produced by the source. This is because the receiver is receiving the same number of waves per second that the source is producing. As a result, any stationary audible sounds, such as fixed fire and smoke alarms, will result in characteristics of stationary stable high frequency waves. Upon receipt of a stationary high pitch sound wave, the flow of energy to the appliance or other device may be disconnected or interrupted. Conversely, the receipt of a non-stationary high pitch sound wave disconnects or interrupts the flow of energy to the appliance or device.

A low pitch sound wave (See FIG. 17B), a sound wave in the form of noise (See FIG. 17C) and a mixture of different sound, such as music tones (See FIG. 17D), for example, may not be sufficient to activate the sound wave valve. Sound waves in the form of noise have no tonal quality as it distracts and distorts the sound quality that was intended to be heard. Generally noise is an unwanted disturbance caused by spurious waves originating from different sources. As a result, disturbed high pitch sounds found in noise are not enough to activate the sound wave valve.

Detection of a Doppler Effect in a sound wave may be utilized to determine if the sound wave valve is to be activated. A sound wave with a Doppler Effect is shown in FIG. 17E. A Doppler Effect is the apparent change in frequency or pitch when a sound source moves either toward or away from the listener, or when the listener moves either toward or away from the sound source. If either the source or the receiver or both move toward the other, the receiver will perceive a higher frequency sound. If the source and the sound wave receiver are moving apart, the receiver will receive a smaller number of sound waves per second and will perceive a lower frequency sound. For example, the frequency of a Police Siren on a fast-moving police car increases in pitch as the Police Car is approaching. Although the Siren is generating high pitch sound waves, the wave is not stable when it is in motion and, as a result, the sound waves will fail to activate the sound wave valve.

As discussed above, a stationary high frequency sound wave, as shown in FIG. 17F, may be utilized to activate the sound wave valve. For example, a fire alarm or smoke detector fixed inside the house may emit a stationary high frequency sound wave activating the sound wave valve. That is, if no change in the pitch or frequency of the sound wave and formation are detected, the sound wave receiver may cut-off the power supply to the valve and the electrical source resulting in the disablement of the appliance or other device by restricting the flow of energy. According to one aspect, any stationary sources of sound waves having high frequency, such as a continuous, stationary, whistle blowing without motion may generate a constant high pitch causing power to be disconnected from the valve (or valve member).

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A system for automatically shutting off an appliance, comprising:
one or more detector modules configured to emit a signal upon an occurrence of an event, the signal in the form of sound waves;
a data transceiver processing module configured to receive a plurality of sound waves and analyze the plurality of sound waves for a variation in frequency to determine if any of the plurality of the sound waves originate from the one or more detectors; and
a control knob unit, in communication with the data transceiver processing module, adapted to be received on an operational shaft of the appliance for controlling an output source from the appliance by rotating between a first position and a second position, and where the control knob unit actuates from the first position to the second position in response to a determination of the plurality of sound waves originating from the one or more detectors.

2. The system of claim 1, wherein the output source is at least one of a gas and electricity for operating the appliance.

3. The system of claim 1, wherein the data transceiver module stores one or more executable programs for actuating the control knob unit between the first and second positions based on a pre-determined schedule.

4. The system of claim 1, further comprising:
a switch board interface; and
a communication device for communicating with the switch board interface;
wherein the switch board interface, in response to receiving a communication from the communication device, sends a message to the control knob unit causing the control knob unit to actuate from the first position to the second position.

5. The system of claim 4, wherein the switch board interface comprises:
a communication interface for receiving an access input code;
a memory device for storing a list of appliance codes; and
a processing circuit coupled between the communication interface and the memory device, the processing circuit configured to:
receive the access input code, the access input code provided remotely using the communication device;
compare the access input code to a list of appliance codes stored in the memory device;
send the message to the control knob unit causing the control knob unit to actuate from the first position to the second position disabling the output source of the appliance.

6. The system of claim 1, wherein the event includes detection of at least one of a fire, smoke, carbon monoxide.

7. The system of claim 1, wherein the one or more detector modules includes at least one of a smoke detector, a carbon monoxide detector, a fire detector, a flame detector and a heat detector.

8. The system of claim 1, wherein the appliance includes at least one of a gas stove, an electric stove, a gas furnace and an electric furnace.

9. The system of claim 1, wherein an occurrence of a Doppler Effect in the plurality of sound waves indicates that the plurality of sound waves emanate from a source different from the one or more detectors.

10. The system of claim 1, wherein the control knob unit comprises:
a housing;
a base panel connected to the housing by a pair of elongated members;
a rotating rod integrally connected to and extending outwardly from the housing through the base panel at a first end and attached to the operational shaft of the appliance at a second end, the second opposite the first end; and
a handle integrally connected to and extending outwardly from the housing for manually rotating the control knob unit.

11. The system of claim 10, wherein the control knob unit further comprises:
a spring encircling the rotating rod, wherein turning the housing clockwise causes the rotating rod to turn clockwise tightening the coils of the spring and where turning the housing counter clockwise causes the rotating rod to turn counter clockwise loosening the coils of the spring.

12. The system of claim 11, wherein the control knob unit further comprises:
a sprocket, having a plurality of teeth, connected to the housing;
a locking mechanism engaged with the sprocket for rotating the knob control unit between a plurality of positions, the locking mechanism comprising:
a mechanism housing;
a latching rod slidably disposed within the mechanism housing and movable between a first position and a second position, wherein the latching rod engages the plurality of teeth of the sprocket when moved from the first position to the second position causing the sprocket to rotate;
a locking spring surrounding the latching rod and adapted to move the latching rod between the first and second positions; and
a solenoid coil surrounding the locking spring and rotating, where an electrical current applied to the solenoid coil energizes the solenoid coil generating a magnetic field biasing the latching rod between the first and second positions.

13. The system of claim 12, wherein the electrical current is provided by a battery located in the handle of the housing.

14. The system of claim 12, wherein the electrical current is provided by the appliance.

15. The system of claim 11, wherein the control knob unit further comprises a motorized locking mechanism, the motorized locking mechanism comprises:
a rotating wheel rotatably engaged with the housing of the control knob unit;
a motor; and
a belt surrounding the rotating wheel and motor;
wherein when energy is delivered to the motor, the motor causes the belt to rotate which in turn rotates the rotating wheel.
